(19) United States
(12) Patent Application Publication
(10) Pub. No.: US 2022/0327203 A1
(43) Pub. Date: Oct. 13, 2022

(54) WHITELIST GENERATION APPARATUS, WHITELIST GENERATION METHOD, AND NON-TRANSITORY COMPUTER READABLE MEDIUM STORING PROGRAM

(71) Applicant: NEC Corporation, Minato-ku, Tokyo (JP)

(72) Inventor: Takayuki SASAKI, Tokyo (JP)

(73) Assignee: NEC Corporation, Minato-ku, Tokyo (JP)

(21) Appl. No.: 17/761,654

(22) PCT Filed: Sep. 27, 2019
(86) PCT No.: PCT/JP2019/038125

§ 371 Date: Mar. 18, 2022

(51) Int. Cl. G06F 21/55

(52) U.S. Cl. CPC G06F 21/552; G06F 2221/033

(57) ABSTRACT

According to an embodiment, a whitelist generation apparatus includes merging means for merging a first whitelist in which first verification data that corresponds to a first program is listed with a second whitelist in which second verification data that corresponds to a second program stored in a library to which the first program is linked is listed, and thus generating a third whitelist in which third verification data is listed.

### TECHNICAL FIELD

The present disclosure relates to a whitelist generation apparatus, a whitelist generation method, and a non-transitory computer readable medium storing a program.

### BACKGROUND ART

It is required that a security check function such as a tamper detection function be introduced into Internet of Things (IoT) devices. For example, Patent Literature 1 discloses an information terminal that verifies whether there is a tampering with each program based on a hash value registered in a whitelist in advance.

Other descriptions regarding security check are disclosed also in Patent Literature 2 and 3.

### CITATION LIST

### Patent Literature

[Patent Literature 1] Japanese Unexamined Patent Application Publication No. 2009-9372
[Patent Literature 2] Japanese Unexamined Patent Application Publication No. 2019-020872
[Patent Literature 3] Japanese Unexamined Patent Application Publication No. 2015-084006

### SUMMARY OF INVENTION

### Technical Problem

Incidentally, most programs executed in IoT devices or the like are constructed by causing a compiled library externally provided to be statically or dynamically linked with the programs.

However, none of the related art discloses or suggests creating a whitelist of a program constructed by causing a library to be statically or dynamically linked with the program. Therefore, in the related art, there is a problem that it is impossible to verify whether there is a tampering with a program constructed by statically or dynamically linking the library with the program.

The present disclosure has been made in order to solve the aforementioned problem. That is, an object of the present disclosure is to provide a whitelist generation apparatus, a whitelist generation method, and a non-transitory computer readable medium storing a program capable of creating a whitelist that corresponds to a program constructed by causing a library to be linked with the program.

### Solution to Problem

A whitelist generation apparatus according to the present disclosure includes merging means for merging a first whitelist in which first verification data that corresponds to a first program is listed with a second whitelist in which second verification data that corresponds to a second program stored in a library to which the first program is linked is listed and thus generating a third whitelist in which third verification data is listed.

Further, a whitelist generation method according to the present disclosure includes a merging step of merging a first whitelist in which first verification data that corresponds to a first program is listed with a second whitelist in which second verification data that corresponds to a second program stored in a library to which the first program is linked is listed and thus generating a third whitelist in which third verification data is listed.

Further, a non-transitory computer readable medium according to the present disclosure stores a program for causing a computer to perform merging processing of merging a first whitelist in which first verification data that corresponds to a first program is listed with a second whitelist in which second verification data that corresponds to a second program stored in a library to which the first program is linked is listed and thus generating a third whitelist in which third verification data is listed.

### Advantageous Effects of Invention

According to the present disclosure, it is possible to provide a whitelist generation apparatus, a whitelist generation method, and a non-transitory computer readable medium storing a program capable of creating a whitelist that corresponds to a program constructed by causing a library to be linked with the program.

### BRIEF DESCRIPTION OF DRAWINGS

FIG. 1 is a block diagram showing a whitelist generation apparatus according to a first example embodiment;

FIG. 2 is a block diagram showing a configuration example of a whitelist generation apparatus according to a second example embodiment;

FIG. 3 is a flowchart showing a whitelist generation method by the whitelist generation apparatus shown in FIG. 2;

FIG. 4 is a diagram showing one example of whitelists of libraries before and after update by update means provided in the whitelist generation apparatus shown in FIG. 2;

FIG. 5 is a block diagram showing a configuration example of an information processing apparatus that checks whether there is a tampering with a program using a whitelist generated by the whitelist generation apparatus shown in FIG. 2;

FIG. 6 is a block diagram showing a configuration example of an information processing apparatus on which a whitelist generation apparatus according to a third example embodiment is mounted;

FIG. 7 is a flowchart showing a whitelist generation method performed by a whitelist generation apparatus provided in the information processing apparatus shown in FIG. 6; and

FIG. 8 is a diagram for describing a method of linking a control flow graph.

### DESCRIPTION OF EMBODIMENTS

Example embodiments of the present invention will be described below with reference to the accompanying drawings. Note that the drawings are in simplified form and the technical scope of the example embodiments should not be interpreted to be limited to the drawings. The same elements are denoted by the same reference numerals and a duplicate description is omitted.

In the following example embodiments, when necessary, the present invention is explained by using separate sections or separate example embodiments. However, those example embodiments are not unrelated with each other, unless otherwise specified. That is, they are related in such a manner that one example embodiment is a modified example, an application example, a detailed example, or a supplementary example of a part or the whole of another example embodiment. Further, in the following example embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may also be used.

Further, in the following example embodiments, the components (including operation steps and the like) are not necessarily indispensable except for cases where the component is explicitly specified or the component is obviously indispensable based on its principle. Similarly, in the following example embodiments, when a shape, a position relation, or the like of a component(s) or the like is mentioned, shapes or the like that are substantially similar to or resemble that shape are also included in that shape except for cases where it is explicitly specified or they are eliminated based on its principle. This is also true for the above-described number or the like (including numbers, values, quantities, ranges, and the like).

### First Example Embodiment

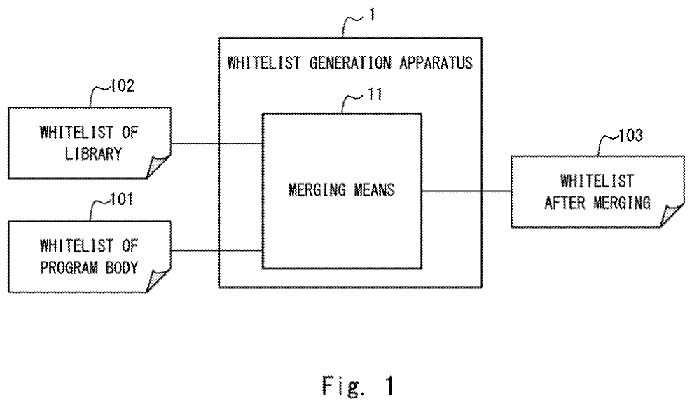

FIG. 1 is a block diagram showing an outline of a whitelist generation apparatus 1 according to the first example embodiment.

As shown in FIG. 1, the whitelist generation apparatus 1 includes merging means 11. The merging means 11 merges a whitelist of a program body 101 executed in an information processing apparatus (not shown) and a whitelist of a library 102 statically or dynamically linked to the program body, thereby generating a whitelist after merging 103. Note that the whitelist of the library 102 is externally provided along the library.

Verification data H1 used to check whether there is a tampering with the program body is listed in the whitelist of the program body 101. Verification data H2 used to check whether there is a tampering with the program stored in the library (that is, the program linked to the program body) is listed in the whitelist of the library 102. Then, verification data H3 obtained by merging the verification data H1 and H2 is listed in the whitelist after merging 103.

The whitelist after merging 103 is input to an information processing apparatus (not shown). The information processing apparatus is an apparatus that executes a program constructed by linking the program body with the library. The information processing apparatus verifies whether there is a tampering with a program by comparing verification data H4 newly generated from the program with the verification data H3 (expectation value) listed in the whitelist 103 when the information processing apparatus executes a program.

As described above, the whitelist generation apparatus 1 is able to generate the whitelist 103 that corresponds to a program constructed by statically or dynamically linking a library. Accordingly, the information processing apparatus that executes the program constructed by statically or dynamically linking a library is able to verify whether there is a tampering with a program using the whitelist 103 generated by the whitelist generation apparatus 1.

### Second Example Embodiment

In this example embodiment, generation of whitelists by the whitelist generation apparatus 1 in a case in which a static link is performed between a program body and a library will be described.

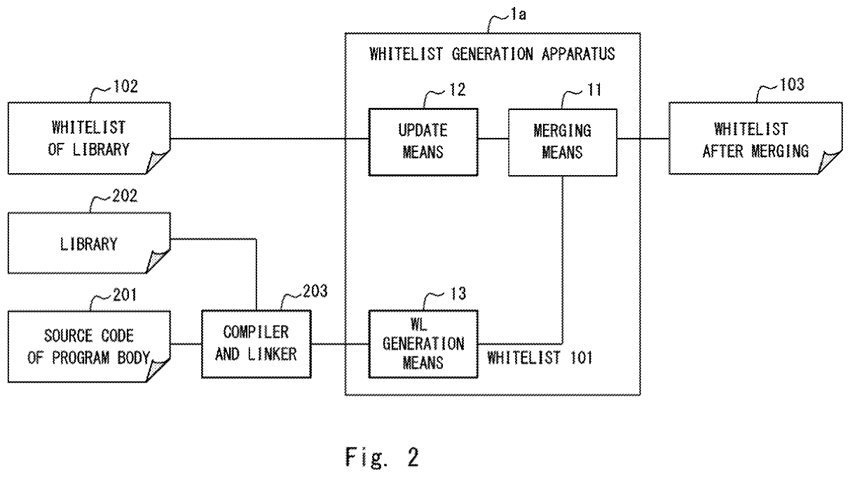

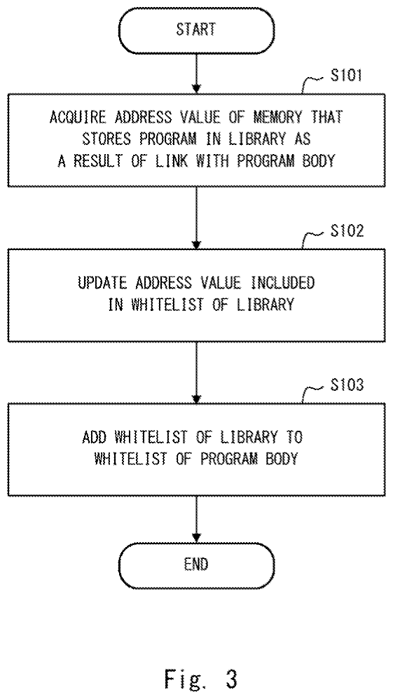

FIG. 2 is a block diagram showing a specific configuration example of the whitelist generation apparatus 1 as a whitelist generation apparatus 1a. Further, FIG. 3 is a flowchart showing a whitelist generation method by the whitelist generation apparatus 1a.

As shown in FIG. 2, the whitelist generation apparatus 1a includes merging means 11, update means 12, and whitelist generation means (WL generation means) 13.

The whitelist generation means 13 generates a whitelist of a program body 101 from results of compiling and linking a source code of a program body 201 and a library 202 using a compiler and linker 203.

Note that verification data H1 listed in the whitelist of the program body 101 means, for example, combinations of address values that specify storage areas in a memory that store the respective parts of the program body, and its hash values. Further, verification data H2 listed in the whitelist 102 of the library 202 means, for example, combinations of address values that specify areas that store the respective parts of the program stored in the library 202, and its hash values.

The update means 12 updates the address value listed in the whitelist 102 of the library 202 based on the address value of the memory that stores the program of the library 202 as a result of a link with the program body.

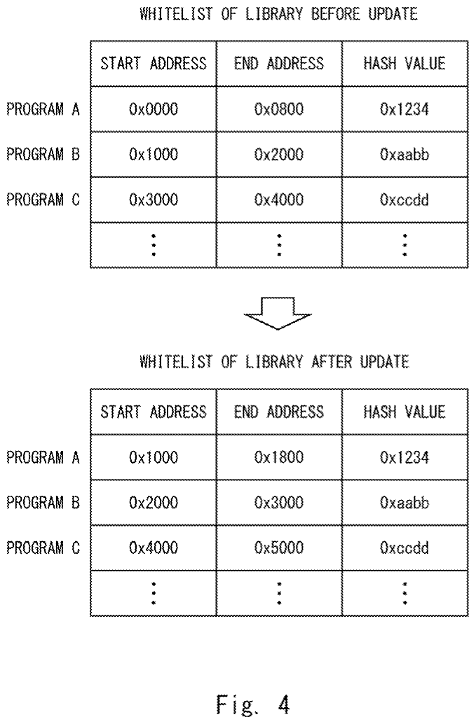

FIG. 4 is a diagram showing one example of the whitelist 102 of the library 202 before update by the update means 12 and the whitelist 102 of the library 202 after update by the update means 12.

As shown in FIG. 4, in the whitelist 102 of the library 202 before the update, a start address value of a program A is “0x0000”, an end address value thereof is “0x0800”, and a hash value of the program A is “0x1234”. Further, a start address value of a program B following the program A is “0x1000”, an end address value thereof is “0x2000”, and a hash value of the program B is “0xaabb”. Further, a start address value of a program C following the programs A and B is “0x3000”, an end address value thereof is “0x4000”, and a hash value of the program C is “0xccdd”.

The update means 12 acquires information on the address value of the memory that stores the program of the library 202 as a result of a link with the program body (Step S101 in FIG. 3). After that, the update means 12 updates the address value listed in the whitelist 102 of the library 202 based on the acquired address value (Step S102 in FIG. 3).

When, for example, the start address value of the memory that stores the program of the library 202 is “0x1000”, the update means 12 rewrites the start address value of the program A from “0x0000” to “0x1000”. In accordance therewith, the end address value of the program A is rewritten from “0x0800” to “0x1800”. Further, the start address value of the program B following the program A is rewritten from “0x1000” to “0x2000”, and the end address value thereof is rewritten from “0x2000” to “0x3000”. Further, the start address value of the program C following the programs A and B is rewritten from “0x3000” to “0x4000”, and the end address value thereof is rewritten from “0x4000” to “0x5000”. Note that the hash values of the programs A, B, and C are not changed before and after the update.

In the above example, the operation of the update means 12 has been described assuming that the whole library is stored in a specific position of the program body. When libraries are stored in different positions for each program, the whitelist may be updated for each position. For example, while 0x1000 is added uniformly in the example shown in FIG. 4, the positions where the respective programs A, B, and C are incorporated may be specified and the start address and the end address of each of the programs A, B, and C may be updated based on the above positions.

The merging means 11 adds information on the whitelist 102 of the library 202 updated by the update means 12 to the whitelist of the program body 101 generated by the whitelist generation means 13 (Step S103 in FIG. 3). Accordingly, the whitelist after merging 103 is generated.

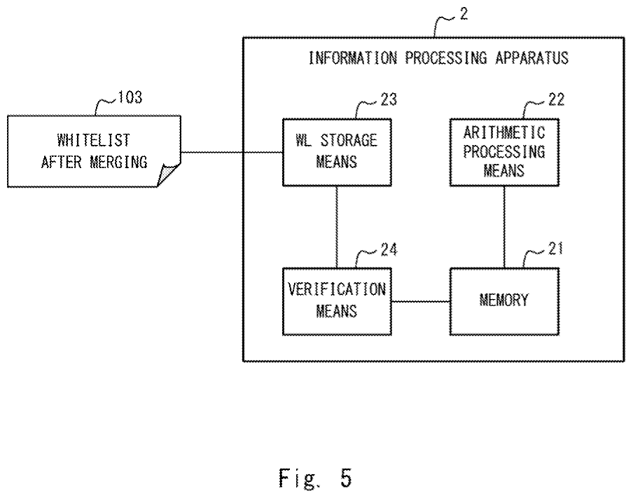

FIG. 5 is a block diagram showing a configuration example of an information processing apparatus 2 that checks whether a program is tampered with using the whitelist 103 generated by the whitelist generation apparatus 1a. The whitelist generation apparatus 1a and the information processing apparatus 2 constitute an information processing system.

As shown in FIG. 5, the information processing apparatus 2 includes a memory 21, arithmetic processing means 22, whitelist storage means (WL storage means) 23, and verification means 24.

The memory 21 stores programs compiled and linked by the compiler and linker 203. The arithmetic processing means 22 executes a program stored in the memory 21. The whitelist storage means 23 stores the whitelist 103 generated by the whitelist generation apparatus 1a.

The verification means 24 verifies, before a program stored in the memory 21 is executed by the arithmetic processing means 22, whether there is a tampering with this program. First, the verification means 24 newly calculates a hash value of each part of the program stored in the memory 21. After that, the verification means 24 verifies whether there is a tampering with a program by comparing the calculated hash value of each part of the program with the hash value (expectation value) that corresponds to each part of the program listed in the whitelist 103.

When, for example, a hash value that corresponds to a program D, which is a part of the program stored in the memory 21, is different from an expectation value, it is determined that the program D is tampered with. In this example, the verification area can be limited and time required for the verification processing can be reduced since hash values are allocated to the respective parts of the program. When an information processing apparatus is mounted on an IoT device, it is especially efficient that the verification area be limited and the time required for the verification processing be reduced since the speed of the CPU, the size of the memory and the like are limited.

As described above, the whitelist generation apparatus 1a is able to generate the whitelist 103 that corresponds to a program constructed by statically linking a library. Accordingly, the information processing apparatus 2 that executes the program constructed by statically linking a library is able to verify whether there is a tampering with a program using the whitelist 103 generated by the whitelist generation apparatus 1a.

### Third Example Embodiment

In this example embodiment, generation of whitelists by the whitelist generation apparatus 1 in a case in which a dynamic link is performed between a program body and a library will be described.

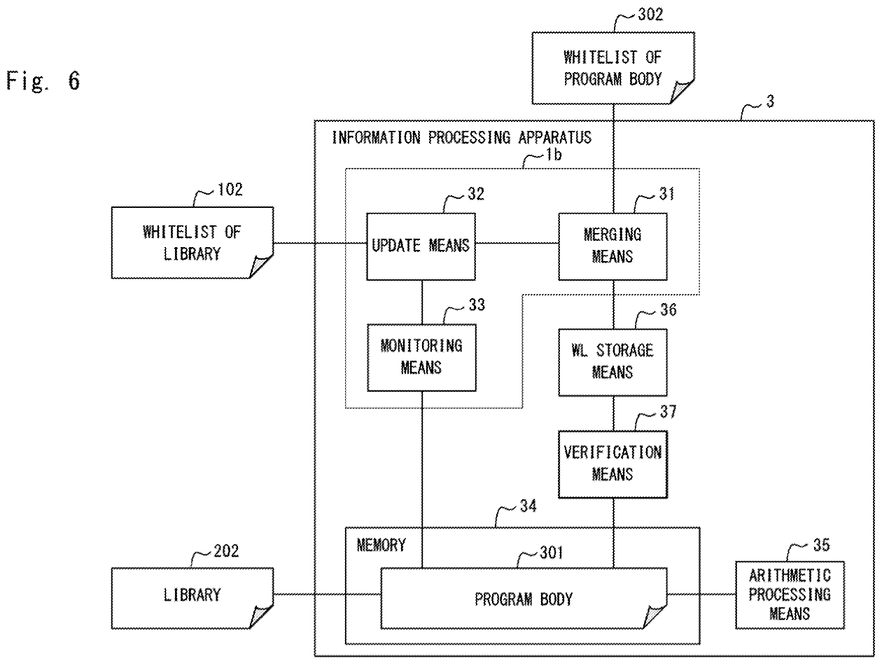

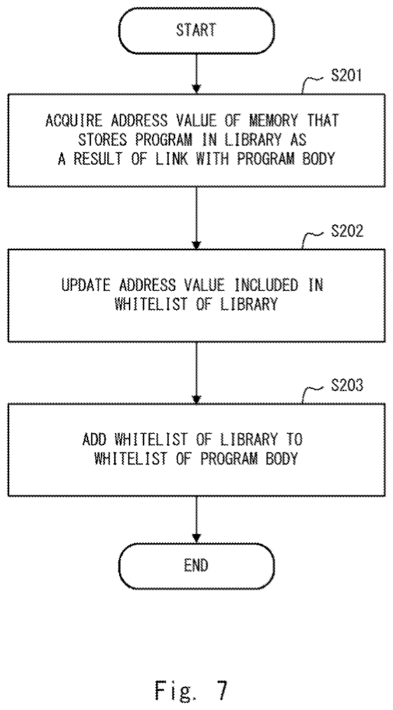

FIG. 6 is a block diagram showing a configuration example of an information processing apparatus 3 on which a whitelist generation apparatus 1b, which is a specific example of the whitelist generation apparatus 1, is mounted. Further, FIG. 7 is a flowchart showing a whitelist generation method by the whitelist generation apparatus 1b.

As shown in FIG. 6, the information processing apparatus 3 includes the whitelist generation apparatus 1b, a memory 34, arithmetic processing means 35, whitelist storage means (WL storage means) 36, and verification means 37. The whitelist generation apparatus 1b includes merging means 31, update means 32, and monitoring means 33.

The memory 34 stores a program body 301. Note that a program stored in the library 202 is specified in the program body 301 as a program to be loaded. The arithmetic processing means 35 executes the program body 301 stored in the memory 34 (and a program in the library 202 dynamically linked).

The monitoring means 33 monitors calling for the program in the library 202 by the program body 301.

When it is detected that the program in the library 202 has been called by the program body 301, the update means 32 acquires information on the address value of the memory 34 in which the called program of the library 202 is to be stored (Step S201 in FIG. 7). After that, the update means 32 updates the address value listed in the whitelist 102 of the library 202 based on the acquired address value (Step S202 in FIG. 7). Since the update means 32 is similar to the update means 12, the description of the details of the update means 32 will be omitted.

The merging means 31 adds information on the whitelist 102 of the library 202 updated by the update means 32 to a whitelist 302 of the program body 301 that has been created in advance (Step S203 in FIG. 7). Accordingly, a whitelist after merging 403 (not shown) is generated. This whitelist 403 is stored in the whitelist storage means 36.

The verification means 37 verifies, before a program stored in the memory 21 is executed by the arithmetic processing means 22, whether there is a tampering with this program. First, the verification means 37 calculates hash values of the respective parts of the program stored in the memory 34. After that, the verification means 37 verifies whether there is a tampering with the program by comparing the calculated hash values of the respective parts of the program with the hash values (expectation values) that correspond to the respective parts of the program listed in the whitelist 403. Further, the timing when the program is verified may be a period during which the program is being executed by the arithmetic processing means 22 or after this program is executed.

As described above, the whitelist generation apparatus 1b is able to generate the whitelist 403 that corresponds to the program constructed by causing a library to be dynamically linked to the program. Accordingly, the information processing apparatus 3 that executes the program constructed by dynamically linking a library is able to verify whether there is a tampering with a program using the whitelist 403 generated by the whitelist generation apparatus 1b.

### Other Example Embodiments

While the case in which combinations of address values specifying storage areas of a memory that store the respective parts of a program, and its hash values is listed in a whitelist has been described as an example in the above second and third example embodiments, this is merely an example.

For example, in place of the hash values, index values (e.g., values of error correcting codes) that can be calculated from the entity of the respective parts of the program and that can be used to check whether there is a tampering may be used.

Alternatively, control flow graphs (CFGs) may be listed in the whitelist.

For example, in the case of the whitelist generation apparatus 1a shown in FIG. 2, the whitelist of the program body 101 stores a control flow graph G1 that expresses a possible order of execution of a plurality of codes when the program body is executed. The whitelist 102 of the library stores a control flow graph G2 that expresses a possible order of execution of a plurality of codes when the program stored in the library is executed.

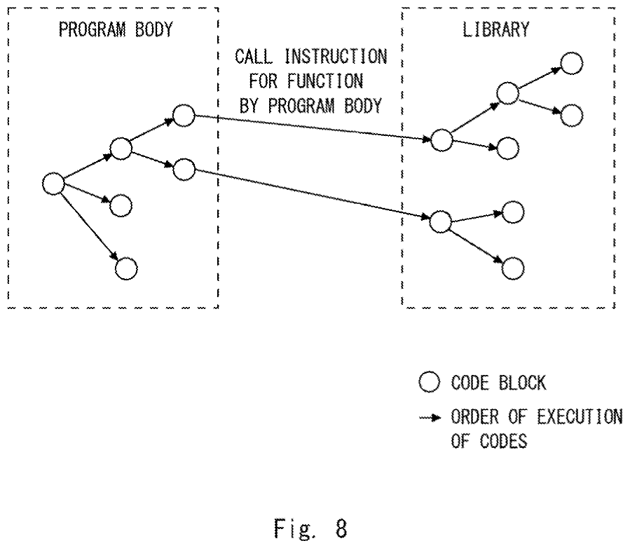

The merging means 11 associates the control flow graphs G1 and G2 with each other based on, for example, a call instruction for a program in the library described in the library body and thus generates a control flow graph G3 (see FIG. 8). Then, the merging means 11 outputs the whitelist 103 that stores the control flow graph G3. While only merging based on the library calling flow is illustrated in FIG. 8, the control flow graphs G1 and G2 may be associated with each other based on the flow of return from the library to the program body.

Then, the information processing apparatus 2 compares a control flow graph G4 newly calculated before the program is executed by the arithmetic processing means with the control flow graph G3 stored in the whitelist 103 generated by the whitelist generation apparatus 1a. Accordingly, it is verified whether there is a tampering with a program (including a tampering with the program itself and a tampering with an order of execution of programs).

Both combinations of address values specifying storage areas of a memory that store the respective parts of the program, and its hash values, and a control flow graph may be listed in the whitelist. It is therefore possible to verify whether there is a tampering with the program more accurately.

While the example embodiments of the present disclosure have been described in detail with reference to the drawings, the specific configurations are not limited to the aforementioned ones and various changes in design may be possible without departing from the spirit of the present disclosure. For example, a function of implementing the operation of the whitelist generation apparatus may be formed of and operated by a plurality of apparatuses connected by a network.

While the present disclosure has been described as a hardware configuration in the aforementioned example embodiments, the present disclosure is not limited thereto. The present disclosure can achieve a part of the processing or the whole processing of the whitelist generation apparatus by causing a Central Processing Unit (CPU) to execute a computer program.

While the whitelist storage means 23 and the verification means 24 are configured to be executed in an area the same as that of a program monitored by hardware or a CPU in the aforementioned example embodiments, they may be configured to be executed in an area separated from the program. According to this configuration, it is possible to prevent the whitelist storage means 23 and the verification means 24 from being attacked through an attacked program. Specifically, the whitelist storage means 23 and the verification means 24 may be configured to be operated by a CPU or a memory other than a CPU or a memory on which the program runs or may be configured to be operated in a TEE provided by the CPU. Note that TEE is an abbreviation for Trusted Execution Environment. TEE may be, for example, Secure World provided by ARM TrustZone. Likewise, the merging means 31, the update means 32, and the monitoring means may be operated in a separated environment.

Further, the above-described program can be stored and provided to a computer using any type of non-transitory computer readable media. Non-transitory computer readable media include any type of tangible storage media. Examples of non-transitory computer readable media include magnetic storage media, optical magnetic storage media, CD-Read Only Memory (ROM), CD-R, CD-R/W, semiconductor memories. Magnetic storage media includes, for example, flexible disks, magnetic tapes, hard disk drives, etc. Optical magnetic storage media include, for example, magneto-optical disks. Semiconductor memories include, for example, mask ROM, Programmable ROM (PROM), Erasable PROM (EPROM), flash ROM, Random Access Memory (RAM), etc. The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present invention has been described above with reference to the example embodiments, the present invention is not limited by the above example embodiments. Various changes that may be understood by those skilled in the art within the scope of the invention may be made to the configurations and the details of the present invention.

### REFERENCE SIGNS LIST

1 Whitelist Generation Apparatus
1a Whitelist Generation Apparatus
1b Whitelist Generation Apparatus
2 Information Processing Apparatus
3 Information Processing Apparatus
11 Merging Means
12 Update Means
13 Whitelist Generation Means
21 Memory
22 Arithmetic Processing Means
23 Whitelist Storage Means
24 Verification Means
31 Merging Means
32 Update Means
33 Monitoring Means
34 Memory
35 Arithmetic Processing Means
36 Whitelist Storage Means
37 Verification Means
101 Whitelist of Program Body
102 Whitelist of Library
103 Whitelist after merging
201 Source Code of Program Body
202 Library
203 Compiler and Linker
301 Program Body
302 Whitelist of Program Body
403 Whitelist after merging
H1˜H4 Verification Data
A˜D Program
G1˜G4 Control Flow Graph

What is claimed is:

1. A whitelist generation apparatus comprising:
at least one first memory storing instructions; and
at least one first processor configured to execute the instructions stored in the first memory to:
merge a first whitelist in which first verification data that corresponds to a first program is listed with a second whitelist in which second verification data that corresponds to a second program stored in a library to which the first program is linked is listed and thus generate a third whitelist in which third verification data is listed.

2. The whitelist generation apparatus according to claim 1, wherein
the first verification data is composed of an address value of a predetermined memory that stores the first program and a first eigenvalue that corresponds to the first program,
the second verification data is composed of a predetermined address value and a second eigenvalue that corresponds to the second program,
the first processor is further configured to execute the instructions to update the address value of the second verification data listed in the second whitelist based on the address value of the predetermined memory where the second program is to be stored as a result of a link with the first program, and
in the mergence and the generation, the first whitelist and the updated second whitelist are merged and thus the third whitelist is generated.

3. The whitelist generation apparatus according to claim 1, wherein
the first verification data is composed of address values of a predetermined memory that store the respective parts of the first program and first eigenvalues that correspond to the respective parts of the first program,
the second verification data is composed of predetermined address values that correspond to the respective parts of the second program and second eigenvalues that correspond to the respective parts of the second program,
the first processor is further configured to execute the instructions to update the respective address values of the second verification data listed in the second whitelist based on the address values of the predetermined memory where the respective parts of the second program are to be stored as a result of a link with the first program, and
in the mergence and the generation, the first whitelist and the updated second whitelist are merged and thus the third whitelist is generated.

4. The whitelist generation apparatus according to claim 1, wherein the first processor is further configured to execute the instructions to calculate the first verification data from the first program to which the second program stored in the library is linked and thus generate the first whitelist.

5. An information processing system comprising:
the whitelist generation apparatus according to claim 1; and
an information processing apparatus to which the third whitelist generated by the whitelist generation apparatus is supplied, wherein
the information processing apparatus comprises:
at least one second memory storing instructions; and
at least one second processor configured to execute the instructions stored in the second memory to:
store the third whitelist supplied from the whitelist generation apparatus;
store the first program and the second program that is linked with the first program in a predetermined memory;
execute the first program and the second program; and
verify whether there is a tampering with the first and second programs by comparing the third verification data listed in the third whitelist with fourth verification data that is newly calculated when the first and second programs are executed.

6. An information processing apparatus comprising:
at least one first memory storing instructions; and
at least one first processor configured to execute the instructions stored in the first memory to:
merge a first whitelist in which first verification data that corresponds to a first program is listed with a second whitelist in which second verification data that corresponds to a second program stored in a library to which the first program is linked is listed and thus generate a third whitelist in which third verification data is listed;
store the third whitelist generated by the whitelist generation apparatus;
store the first program and the second program that is linked with the first program in a predetermined memory;
execute the first program and the second program; and
verify whether there is a tampering with the first and second programs by comparing the third verification data listed in the third whitelist with fourth verification data that is newly calculated when the first and second programs are executed.

7. The information processing apparatus according to claim 6, wherein
the first verification data is composed of an address value of the predetermined memory that stores the first program and a first eigenvalue that corresponds to the first program,
the second verification data is composed of a predetermined address value and a second eigenvalue that corresponds to the second program, and
the first processor is further configured to execute the instructions to update the address value of the second verification data listed in the second whitelist based on the address value of the predetermined memory where the second program is to be stored as a result of a link with the first program.

8. The information processing apparatus according to claim 6, wherein
the first verification data is composed of address values of the predetermined memory that store the respective parts of the first program and first eigenvalues that correspond to the respective parts of the first program,
the second verification data is composed of predetermined address values that correspond to the respective parts of the second program and second eigenvalues that correspond to the respective parts of the second program, and
the first processor is further configured to execute the instructions to update the respective address values of the second verification data listed in the second whitelist based on the address values of the predetermined memory where the respective parts of the second program are to be stored as a result of a link with the first program.

9. The information processing apparatus according to claim 7, wherein
the first processor is further configured to execute the instructions to monitor calling for the second program by the first program, and
in the updating of the address value, when it is detected that the second program has been called by the first program, each address value of the second verification data listed in the second whitelist is updated based on the address value of the predetermined memory where the second program is to be stored as a result of a link with the first program.

10. The whitelist generation apparatus according to claim 1, wherein
the first verification data is a first control flow graph expressing a possible order of execution of a plurality of codes when the first program is executed,
the second verification data is a second control flow graph expressing a possible order of execution of a plurality of codes when the second program is executed, and
in the mergence and the generation, the third whitelist by associating the first control flow graph with the second control flow graph is generated based on a call instruction for the second program in the first program.

11. An information processing apparatus comprising:
at least one first memory storing instructions; and
at least one first processor configured to execute the instructions stored in the first memory to:
merge a first whitelist in which first verification data that corresponds to a first program is listed with a second whitelist in which second verification data that corresponds to a second program stored in a library to which the first program is linked is listed and thus generate a third whitelist in which third verification data is listed, the first verification data being a first control flow graph expressing a possible order of execution of a plurality of codes when the first program is executed, the second verification data being a second control flow graph expressing a possible order of execution of a plurality of codes when the second program is executed, and in the mergence and the generation, the third whitelist by associating the first control flow graph with the second control flow graph being generated based on a call instruction for the second program in the first program;
store the third whitelist generated by the whitelist generation apparatus;
store the first program and the second program that is linked with the first program in a predetermined memory;
execute the first program and the second program; and
verify whether there is a tampering with the first and second programs by comparing the third verification data listed in the third whitelist with fourth verification data that is newly calculated when the first and second programs are executed.

12. A whitelist generation method comprising merging a first whitelist in which first verification data that corresponds to a first program is listed with a second whitelist in which second verification data that corresponds to a second program stored in a library to which the first program is linked is listed and thus generating a third whitelist in which third verification data is listed.

13. The whitelist generation method according to claim 12, wherein
the first verification data is composed of an address value of a memory that stores the first program and a first eigenvalue that corresponds to the first program,
the second verification data is composed of a predetermined address value and a second eigenvalue that corresponds to the second program,
the whitelist generation method further comprises updating the address value of the second verification data listed in the second whitelist based on the address value of the memory where the second program is to be stored as a result of a link with the first program, and
in the mergence and the generation, the first whitelist and the updated second whitelist are merged and thus the third whitelist is generated.

14. The whitelist generation method according to claim 12, wherein
the first verification data is composed of address values of a memory that store the respective parts of the first program and first eigenvalues that correspond to the respective parts of the first program,
the second verification data is composed of predetermined address values that correspond to the respective parts of the second program and second eigenvalues that correspond to the respective parts of the second program,
the whitelist generation method further comprises updating the respective address values of the second verification data listed in the second whitelist based on the address values of the memory where the respective parts of the second program are to be stored as a result of a link with the first program, and
in the mergence and the generation, the first whitelist and the updated second whitelist are merged and thus the third whitelist is generated.

15. The whitelist generation method according to claim 12, wherein
the first verification data is a first control flow graph expressing a possible order of execution of a plurality of codes when the first program is executed,
the second verification data is a second control flow graph expressing a possible order of execution of a plurality of codes when the second program is executed, and
in the mergence and the generation, the first control flow graph is associated with the second control flow graph based on a call instruction for the second program in the first program.

16. The whitelist generation method according to claim 12, further comprising calculating the first verification data from the first program to which the second program stored in the library is linked and thereby generating the first whitelist.

17. An information processing method comprising:
verifying whether there is a tampering with the first and second programs by comparing the third verification data listed in the third whitelist generated by the whitelist generation method according to claim 12 with fourth verification data that is newly calculated when the first and second programs are executed; and
executing the first and second programs when it is determined that there is no tampering with the first and second programs.

18. An information processing method comprising:
verifying whether there is a tampering with the first and second programs by comparing the third verification data listed in the third whitelist generated by the whitelist generation method according to claim 13 with fourth verification data that is newly calculated when the first and second programs are executed; and
executing the first and second programs when it is determined that there is no tampering with the first and second programs, wherein
the whitelist generation method further comprises monitoring calling for the second program by the first program, and
in the updating of the address value, when it is detected that the second program has been called by the first program, each address value of the second verification data listed in the second whitelist is updated based on the address value of the memory where the second program is to be stored as a result of a link with the first program.

19. A non-transitory computer readable medium storing a program for causing a computer to execute merging processing of merging a first whitelist in which first verification data that corresponds to a first program is listed with a second whitelist in which second verification data that corresponds to a second program stored in a library to which the first program is linked is listed and thus generating a third whitelist in which third verification data is listed.
